(19) United States
(12) Patent Application Publication
(10) Pub. No.: US 2004/0108851 A1
(43) Pub. Date: Jun. 10, 2004

(54) Simplified position or displacement sensor and use thereof

(76) Inventors: Jean Fourcade, Champs Sur Marne (FR); Stephane Gendrin, Bruz (FR); Olivier Masson, Paris (FR)

Correspondence Address: Leo H McCormick Jr, Bosch Braking Systems, 2112 Mishawake Avenue, P O Box 4721, South Bend, IN, 46634-4721, US

(21) Appl. No.: 10/475,643

(22) PCT Filed: Mar. 21, 2002
(86) PCT No.: PCT/FR02/00984

(30) Foreign Application Priority Data
Mar. 23, 2001 (FR) 01/04054

(51) Int. Cl. G01B 7/14

(52) U.S. Cl. 324/207.17; 324/207.22; 324/207.26

(57) ABSTRACT

The invention relates to a position or displacement sensor comprising a detection circuit and a rider (2), the position of which is detected by the detection circuit, this rider (2) comprising a support (20) consisting of a material inert to the detection circuit, and an influencing member (21) carried by the support (20) and comprising a material that is active to the detection circuit. The influencing member (21) is produced in the form of particles (P) of the active material which are embedded in a mass (M) of the inert material to measurement of the displacement or position of a motor vehicle braking system piston.

The invention relates, in general, to the field of geometric sensors designed for industrial applications.

More specifically, according to a first of its aspects, the invention relates to a position or displacement sensor, comprising a detection circuit and a rider, the rider being mounted so that it can move with respect to the detection circuit and comprising a support and an influencing member, the support consisting of a first material, which is inert to the detection circuit, the influencing member being carried by the support and comprising a second material which is active to the detection circuit, and the detection circuit delivering an output signal that is a function of a relative position of the influencing member and of the detection circuit.

In this type of sensor, the influencing member needs, in a known way, to meet very tight dimensional tolerances and be able to adopt a very precise reference position with respect to the detection circuit.

The solution adopted in order to meet these requirements traditionally consists in attaching to the support the influencing member which is obtained by separate manufacture.

While such an approach is satisfactory from the viewpoint of the precision of the measurements made with such a sensor, the manufacture thereof is, on the other hand, relatively lengthy and tricky and therefore expensive.

In this context, the object of the invention is, in particular, to provide a precise position or displacement sensor, but one which is nonetheless simpler to manufacture than the known sensors.

To this end, the sensor of the invention, which in other respects is in accordance with the generic definition given in the preamble above, is essentially characterized in that the influencing member is produced in the form of particles of the second material which are embedded in a mass of the first material.

It is thus possible, in particular, to produce more simply a sensor in which the detectin circuit comprises a magnetic field generator and a magnetic field detector and in which the influencing member performs, between the mangetic field generator and dector, magnetic coupling which variew according to its relative positon with respect to the detection circuit.

In this case, the first material is generally a dielectric, for example a thermoplastic polymer, while the second material is an electric conductor, for example a metal or an alloy.

In practice, the rider may comprise a stud allowing it to be linked in terms of displacement to a moving part by means of a clip.

When the first material is a thermoplastic polymer, the rider may be obtained by moulding or by injection.

Although the sensor of the invention can have numerous applications, it is particularly well suited to measuring the displacement or the position of a motor vehicle braking system piston.

Other features and advantages of the invention will become clearly apparent from the description thereof given hereinafter by way of nonlimiting indication, with reference to the appended drawings.

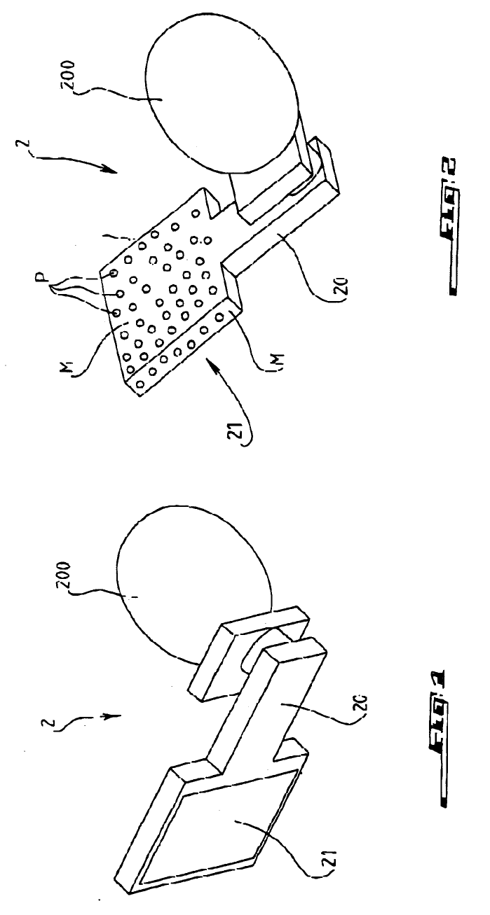

FIG. 1 is a perspective view of a rider belonging to an known sensor;

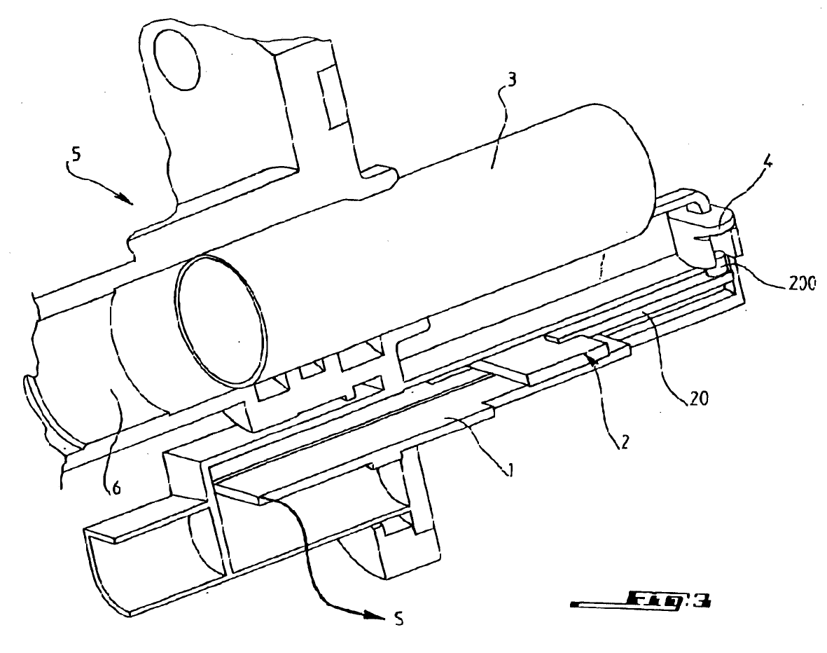

FIG. 2 is a perspective view of a rider belonging to a sensor according to the invention;

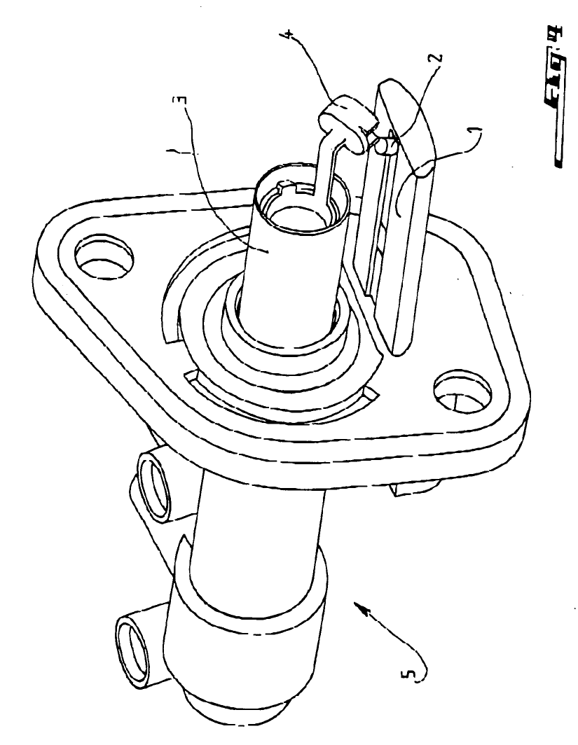

FIG. 3 is a perspective view of a rider according to the invention, depicted in combination with a master cylinder piston which is illustrated in part and with cutaway; and

FIG. 4 is a perspective view of a master cylinder depicted completely and using a sensor according to the invention.

As mentioned earlier, the invention relates to a position or displacement sensor of the type comprising a detection circuit 1 (FIG. 3) and a rider 2 (FIGS. 2 and 3).

The rider 2 is mounted so that it can move with respect to the detection circuit 1 and comprises a support 20 and an influencing member 21, the influencing member 21 being carried by the support 20.

The support 20 consists of a material that is inert to the detection circuit 1, while the influencing member 21 consists of a material which is active to this detection circuit 1.

This being the case, the detection circuit 1 delivers (FIG. 3) an output signal S which is a function of the instantaneous position adopted by the influencing member 21 with respect to the detection circuit 1, the change in the output signal thus being representative of the relative displacement of the rider 2 with respect to the detection circuit 1.

As FIG. 1 shows, the influencing member, in known sensors, consists of a plate, such as a copper plate, fixed to the support 20.

Contrastingly, according to the invention, as shown by FIG. 2, the influencing member 21 is produced in the form of particles P of the material which is active to the detection circuit 1, these particles P being embedded in a mass M of the material which is inert to the detection circuit 1.

The inert material consists, for example, of a dielectric material such as a thermoplastic polymer.

In the latter case, the rider 2 may in particular be obtained by moulding or by injection.

The active material may, for its part, consist of an electrically conducting material, for example a metal or an alloy.

It is thus possible to produce an inductive position or displacement sensor which works by magnetic coupling.

More specifically, in this case, the detection circuit 1 comprises a magnetic field generator and a magnetic field detector and the influencing member 21 has the function of performing, between the magnetic field generator and detector, magnetic coupling which varies according to its relative position with respect to the detection circuit 1.

The output signal S of the detection circuit 1 is then the one produced by the magnetic field detector, namely a signal dependent upon the magnetic coupling achieved by the influencing member 21 and therefore ultimately dependent upon the position thereof.

As is shown in particular by FIG. 2, the rider 2 comprises, for example, a stud 200 formed on the support 20 and allowing the rider 2 to be linked cinematically with a moving part 3 secured to a clip 4 which fits over the stud 200.

As FIGS. 3 and 4 show, the moving part 3 consists, for example, of a piston of a motor vehicle braking master cylinder 5, this piston 3 being slidably mounted in a cylinder 6 of this master cylinder.

This being the case, the sensor of the invention at all times supplies, in the form of the output signal S it delivers, a measurement of the displacement or of the position of the piston 3 inside the cylinder 6.

1. A position or displacement sensor for sensing the position or displacement of a piston (3) of a motor vehicle braking system, comprising a detection circuit (1) and a rider (2), the rider (2) being mounted so that it can move with respect to the detection circuit (1) and comprising a support (20) and an influencing member (21), the support (20) consisting of a first material, which is inert to the detection circuit (1), the influencing member (21) being carried by the support (20) and comprising a second material which is active to the detection circuit (1), and the detection circuit (1) delivering an output signal (S) that is a function of a relative position of the influencing member (21) and of the detection circuit (1), characterized in that the influencing member (21) is produced in the form of particles (P) of the second material which are embedded in a mass (M) of the first material.

2. The position or displacement sensor according to claim 1, characterized in that the detection circuit (1) comprises a magnetic field generator and a magnetic field detector and in that the influencing member (21) performs, between the magnetic field generator and detector, magnetic coupling which varies according to its relative position with respect to the detection circuit (1).

3. The position or displacement sensor according to claim 1,, characterized in that the first material is a dielectric.

4. The position or displacement sensor according to claim 3, characterized in that the second material is an electric conductor.

5. The position or displacement sensor according to claim 5, characterized in that the first material is a thermoplastic polymer.

6. The position or displacement sensor according to claim 5, characterized in that the second material is a metal or an alloy.

7. The position or displacement sensor according to claim 6, characterized in that the rider (2) comprises a stud (200) allowing it to be linked in terms of displacement to a moving part (3) by means of a clip (4).

8. The position or displacement sensor according to claim 7, characterized in that the rider (2) is obtained by moulding.

9. The position or displacement sensor according to claim 8, characterized in that the rider (2) is obtained by injection.
